(19) United States
(12) Patent Application Publication
(10) Pub. No.: US 2016/0364768 A1
(43) Pub. Date: Dec. 15, 2016

(54) APPLICATION DRIVEN MARKETING SYSTEM

(71) Applicant: Paul Sadler, Huntington Beach, CA (US)

(72) Inventor: Paul Sadler, Huntington Beach, CA (US)

(21) Appl. No.: 14/736,253

(22) Filed: Jun. 10, 2015

(51) Int. Cl. G06Q 30/02

(52) U.S. Cl. CPC G06Q 30/0276; G06Q 30/0242

(57) ABSTRACT

A system for creating online audiovisual advertisements targeted to an individual consumer, receives direct point of sale initiation from a mobile device or other computer, including the capturing or selecting of images, theme and contact information for the consumer. The system communicates necessary instructions to a server to create custom audiovisual content through cloud computer audiovisual processing, and further sends links to the created audiovisual advertisement to the targeted consumer in order to view online, and provides the consumer the means to continue to redistribute through social media. The entire campaign is automated and trackable, allowing the advertiser feedback on the entire lifecycle of the ad.

### CROSS-REFERENCE TO RELATED APPLICATIONS

This application is related to and claims the priority of U.S. Provisional Patent Application Ser. No. 62/010,397, entitled “APPLICATION DRIVEN MARKETING SYSTEM” filed Jun. 10, 2014, which is hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Conventional systems for media advertisement are limited in nature by a particular product, ability and/or company dealing with such advertisements. It is difficult for conventional media or advertisement companies to create media and track media effectively for a particular client or entity while delivering a clear path from media, to prospective consumer.

### SUMMARY OF THE INVENTION

In an aspect of one embodiment, an automated and targeted media advertisement creation system including, but not limited to tracking, statistics, and direct linking from ad viewer to ad generator.

### BRIEF DESCRIPTION OF THE DRAWINGS

FIG. 1 is an illustration of a mobile device or mobile computer connected to the internet for use in delivering content, instructions, meta data and request of creation of audiovisual works by way of the present invention;

FIG. 2 is an illustrated representation of the system relating to audiovisual creation by way of the present invention;

FIG. 3 is an illustrated representation of the general user interface in the onset of creation of audio visual creation by way of the present invention;

FIG. 4 is an illustrated representation of the internal system architecture and relation of present invention; and

FIG. 5 is an illustrated diagram of the advertisement or method architecture of the present invention.

### DETAILED DESCRIPTION OF THE INVENTION

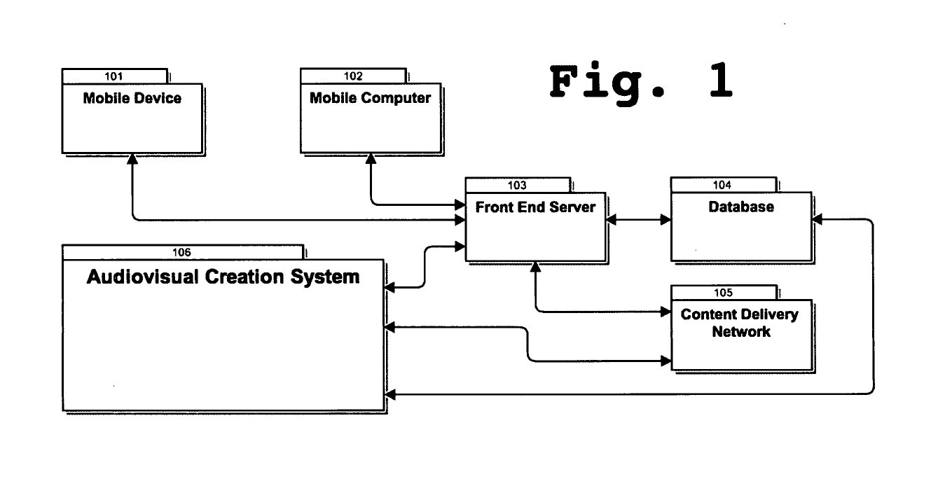

FIG. 1 illustrates a point of sale mobile computing device 101 or a mobile computer 102 connected to the internet, sending media and instructions to a front end cloud server 103 in which data is sent to a database 104. Media is then sent via a file storage Content Delivery Network 105 and instruction to create with directions are sent to audiovisual creation system 106 via a network (internet) connection.

In one embodiment a mobile device 101 is used to set forth the creation of an audiovisual master piece. In another embodiment a mobile computer 102 is used to set forth the creation of an audiovisual masterpiece. When creation is instructed by either method, the front end server 103 is then queried to initiate such task. In one embodiment, the front end server 103 sends information to a database 104 via a network or other data connection. In another embodiment, the front end server 103 receives data from database 104 via a network or other data connection in order to ascertain information to further the process. In another embodiment, a Content Delivery Network server via a network or other data connection 105 is delivered media files to be stored temporarily until the creation of the final audiovisual masterpiece. In a further embodiment, the front end server 103 via a network or other data connection instructs the audio visual creation system 106 how to create final audiovisual masterpiece. During this process, in one embodiment, the audiovisual creation system 106 will collect information from front end server 103 via a network or other data connection. It will collect it as data and instructions, from the database 104 via a network or other data connection as data, whether new or stored, such as meta data, and from the Content Delivery Network server 105 via a network or other data connection as data and/or media, whether new or stored, such as audio content.

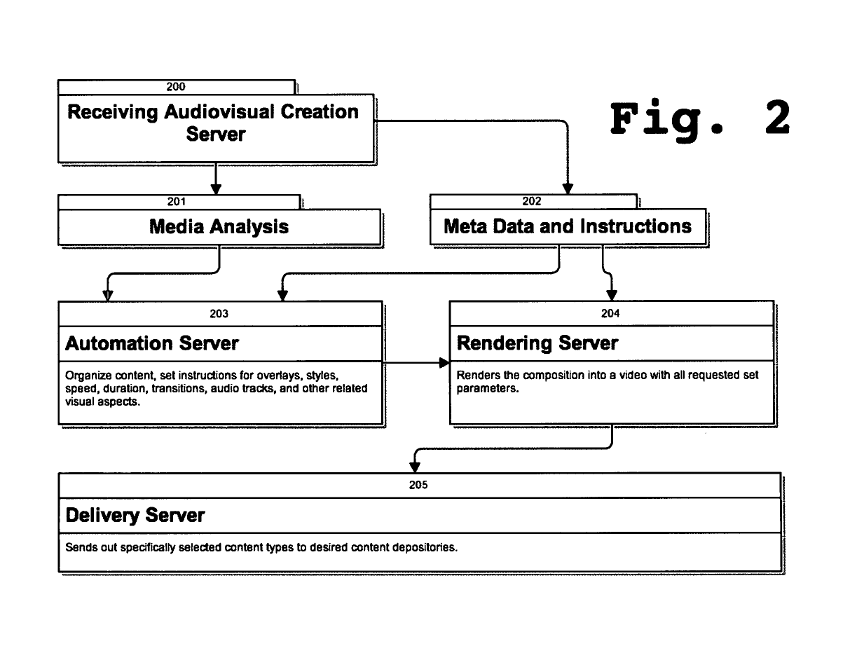

FIG. 2 illustrates audiovisual creation and storage system to create an audiovisual masterpiece. After receiving communications, data, and files from FIG. 1 to the “receiving audiovisual creation system” FIG. 2/200, in one embodiment, the creation process commences and some or all of these processes may move forward: An analysis 201 of the data, meta data, files, and media may be performed; Meta data and instructions 202 are filtered to the automation server 203 and the rendering server 204; The media analysis 201 information may be delivered to the automation server 203; The rendering server 204 will identify the task at hand from the automation server 203 and/or the rendering server 204.

In one embodiment, the rendering server 204 will request proper media, data, and metadata to create audiovisual masterpiece. In another embodiment, the rendering server 204 will process such data and media to create said masterpiece. In another embodiment, the rendering server 204 will direct the created masterpiece to delivery server 205, and in another embodiment, the delivery server 205 will store and send said masterpiece to pre-selected repositories or recipients as indicated by metadata and instructions 202 and/or from automation server 203, filtered through rendering server 204 to delivery server 205.

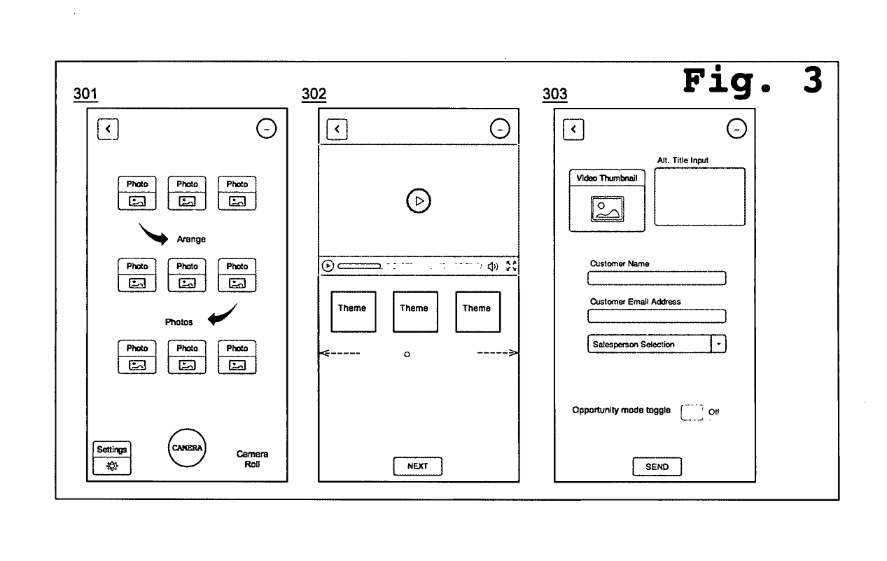

The onset of creation may or may not be limited to a user interface that exists within a mobile and/or mobile computer application as illustrated in FIG. 3. In one embodiment, the process is initiated by pressing buttons to take photos or videos 301 or selecting photos 301 from preexisting media stored on mobile device. In another embodiment, a theme will be selected 302 that will indicate the accompanied audio/music and the graphical treatment, timing, speed for desired masterpiece. In a further embodiment 303, field entries will be entered for the desired delivery address, customer's name and/or special title, selection of the users name from list, and the ability to set a specialized toggle, identifying the masterpiece as a particular creation type via a data entry to FIG. 1/104 database of the front end server 103.

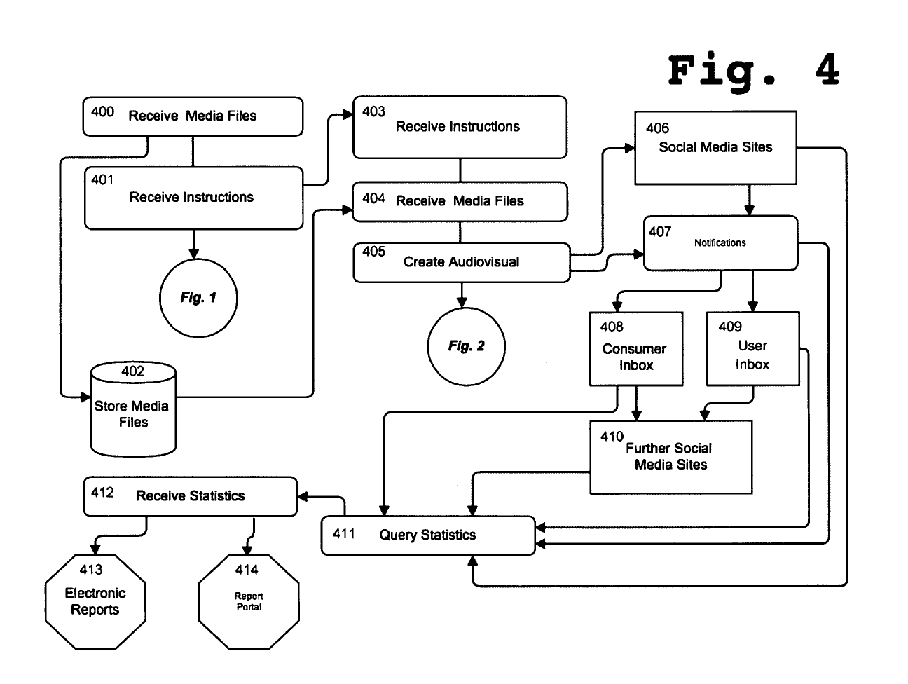

In a non-mechanical overview of how the system functions for creation of audiovisual masterpiece, refer to FIG. 4. The system functions by receipt of files, data, and instructions from a device or like module, but not limited to as indicated in FIG. 3/301-303. In FIG. 4 as described, media files are received 400 and passed through to storage 402. Received instructions from front end server 103 are then passed to audiovisual creation system 403, where the audiovisual creation system is instructed 403 to request required media, data and/or other content 404 and then create the audiovisual masterpiece 405. In another embodiment, the audio visual creation system is instructed to deliver the masterpiece to pre-determined recipients and/or specifically configured social media sites, and in a further embodiment, is instructed to send notification 407 of success or failure of delivery to said sites. In another embodiment, notifications 407 are also sent as emails to desired entities 408-409 as pre-determined during the initial setup of user's account and by as indicated in selection during the instructed creation process 303 and in another embodiment, the user or customer may receive SMS messages 408-409 indicating process details and/or preview media or final advertisement/s. In another embodiment, the delivered email notifications or SMS notifications 408-409, if desired by recipient/s, are shared via social media platforms 410, not limited to the platforms that may be part of the current system or confined by the current system or future systems that may be implemented to best serve that specific area of marketing or availability of said market relating to social media. In a further embodiment, statistics 411 are gathered on the traffic and/or related, trackable actions of the audiovisual masterpieces as they make their way through all perceivable electronic advertising methods, and not limited to only social media proliferation. In another embodiment, the statics gathered 412 are then interpreted and delivered to a user of the system by electronic, visual report 413, as well as a web based area 414 provided to users of the system for continued monitoring day-today.

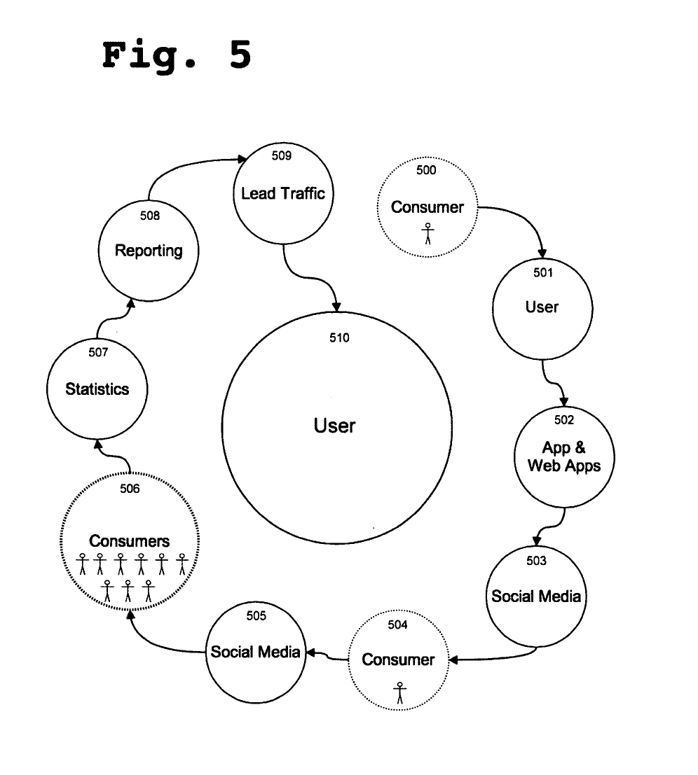

The present invention utilizes an approach in this specialized area of marketing by performing many processes through one system in order to resolve the complexity of what other systems rely on to yield only a portion of what the present invention is able to achieve. FIG. 5 illustrates the relation and process and/or the philosophy in which the system conveys. A consumer 500 may visit a user 501 of the present invention. This consumer 500 then may purchase from said user 501. The user may then initiate the application 502 and capture the moment of the purchase or related media of the purchase and in another embodiment, may capture media in lieu of initial contact with consumer. After application process is initialized, Delivery Server 205 and social media repositories 503 are uploaded to. Consumers 504 receive invitations to share media further via social media 505 and other outlets. By the process of social media proliferation, many possible new consumers 506 are informed of the initial consumer 500 experience. Statistics 507 are gathered concerning the new probable consumers 506. Reporting 508 is delivered, as well as directed lead traffic 509 to users 510 via web links, SMS, advertisements, portals, live chats, but not limit to one and may include future platforms or technologies not available or present at this point in time.

The advantages of the present invention include, but without limitation, is allowing a user (business) to turn an average interaction with a consumer into a full-circle advertisement campaign, with an added advantage to track its full success. It is essentially, an all-in-one system and automated to make ones job simple.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A system for creating and distributing an audiovisual advertisement to a consumer, comprised of:
a computing device to gather and organize content and initiate creation of an audiovisual advertisement;
a system that receives from said computing device instructions and content to automatically create said audiovisual advertisement;
a mechanism for delivery of said audiovisual advertisement to said consumer; and
a mechanism that allows users of said system to review statistics and effectiveness of said audiovisual advertisement.

2. The system described in claim 1, further comprised of:
a point of sale mobile computing device with software to enable capture or selection of photographs and video relating to the particular item of sale, optionally with consumer in said photographs and video;
an online audiovisual creation system that receives from said mobile computing device the audiovisual content, theme, title, and electronic contact information for the consumer, in order to produce and distribute the audiovisual advertisement;
online delivery server and software that transmits electronic messages to said consumer, providing links in said messages to direct consumer to web pages that will present said audiovisual advertisement, including social media sharing links to encourage redistribution of advertisement by said consumer along with embedded linking system that directs traffic to user website (URL); and
an online web portal with software to allow the user of the system to track the progress and effectiveness of said audiovisual advertisement.
